(19) United States
(12) Patent Application Publication
(10) Pub. No.: US 2017/0053328 A1
(43) Pub. Date: Feb. 23, 2017

(54) COMMUNITY PURCHASING MODEL

(71) Applicants: Jerome Shneider, Northbrook, IL (US); Albert J. Montano, Highland Park, IL (US)

(72) Inventors: Jerome Shneider, Northbrook, IL (US); Albert J. Montano, Highland Park, IL (US)

(21) Appl. No.: 15/242,869

(22) Filed: Aug. 22, 2016

Related U.S. Application Data
(60) Provisional application No. 62/208,636, filed on Aug. 22, 2015.

(51) Int. Cl. G06Q 30/06; G06Q 30/02

(52) U.S. Cl. CPC G06Q 30/0605; G06Q 30/0222

(57) ABSTRACT

A community purchase model for increasing transparency and information symmetry to marketplaces is provided. The community purchase model provides a method for creating and publishing user-buyers' intentions to enter into a deal which other user-buyers can associate with, for setting the terms of the deal, for marketing the deal through their online social networks, and for user-sellers to commit to. Only if the intention is sufficiently fulfilled by a commitment of a user-seller does money change hands, thereby providing a transparent demand curve for predicting reasonable volume sales for the user-seller, while generating a highly personalized deal for the user-buyer and creating new equilibrium prices based on more symmetrical information.

### CROSS-REFERENCE TO RELATED APPLICATION

This application claims the benefit of priority of U.S. provisional application No. 62/208,636, filed 22 Aug. 2015, the contents of which are herein incorporated by reference.

### BACKGROUND OF THE INVENTION

The present invention relates to buying and selling models and, more particularly, to a community purchase model for providing transparency and information symmetry to marketplaces.

It has been said that marketplaces are ancient information systems wherein, for thousands of years, buyer and sellers have gathered to exchange information on the value of countless articles for sale. Throughout this time, however, the marketplace has suffered from, among other things, the age-old problem of information asymmetry. Information asymmetry deals with decisions in transactions where one party has more or better information than the other. This creates an imbalance of power in transactions, which can sometimes cause the transactions to go awry: a market failure.

The Internet and the online marketplaces it has spawned have been hailed as a solution to the information asymmetry. For example, online daily deal websites are marketplaces that connect merchants to consumers by offering goods and services at a discount. This standard system of selling and buying, though, has the same asymmetrical frailties of brick and mortar markets (as well as the bazaars of Persia) requiring sellers to sell goods or services based upon predefined prices and terms set by the seller (e.g., coupons) wherein using coupons offers limited utility to the buyer as they do not have any influence over what products or services are being offered, nor do they have any influence over the terms of the deal, which are often notoriously limited and constricting.

On the other hand, sellers try to anticipate consumer demand through market research, seasonality, focus groups and the like. Because these projections are based on approximations, there are often stark differences between what sellers believe consumers want and what their real demand curve happens to be—i.e., information asymmetry. As a result, buyers are at the behest of sellers as they (the sellers) set the price and the terms of the deal. In addition, the sellers oftentimes find limited utility in the deal as the merchandise or service is heavily discounted thus reducing margins and rarely lead to repeat business.

There are fundamental flaws in the daily deals model. Consumers are tired of inboxes getting clogged with mindless deals, they have zero influence on the terms of the deal itself and sellers are finding that their thin profit margins do not support the fees charged by the daily deal sites to be listed on the site.

As can be seen, there is a need for a community purchase model for providing transparency and information symmetry to marketplaces. The community purchase model addresses the abovementioned problems by empowering the consumer/buyer to create an intention to buy, set the terms of the deal and ultimately market the deal through their social networks. Only if the intention is fulfilled by a seller does money change hands, guaranteeing reasonable volume sales for the seller and generating a highly personalized deal for the buyer. And as a result, these collective intentions will create new equilibrium prices that did not previously exist, previously unknown markets can be discovered, uncommon discounts can be generated and buyers can be empowered to the point where they themselves set the price and terms of the deal, resulting in an economic model that may change the way products and services are sold.

Responses and interactions are required from multiple parties including 1) other buyers who may opt in and/or out of pre-existing intentions; 2) user-sellers (vendors) who accept, modify or create counter intentions and 3) user-buyers and user-sellers who must indicate their acceptance of the various indicated intentions. Thereby, the community purchase model captures users' intentions to buy a product or service, allowing the user to set the price and exact terms of the intention. As other users commit to a given intention, the potential for large sales volumes is generated, compelling sellers to be informed of the captured intentions that they are potentially able and willing to fulfill.

### SUMMARY OF THE INVENTION

In one aspect of the present invention, a community purchase model for providing transparency and information symmetry to marketplace includes publishing a list of intentions according to a category, wherein each intention is associated with a primary user-seller, wherein each intention includes a deal terms and a category of the intention, wherein the deal terms define a specifications of respective intention, and wherein the list is searchable according to the category or the deal terms; receiving an association request from at least one secondary user-buyer for at least one selected intention of the list of intentions; associating the at least one secondary user-buyer with the at least one selected intention; and receiving a fulfillment request from at least one user-seller for the at least one selected intention, whereby the intention is fulfilled according to the deal terms when only one fulfillment request is received.

In another aspect of the present invention, the community purchase model includes publishing a list of intentions according to a category, wherein each intention is associated with a primary user-seller, wherein each intention includes a deal terms and a category of the intention, and wherein the list is searchable according to the category or the deal terms; the deal terms include: a definition of a specifications of respective intention; a cutoff time, wherein the cutoff time defines an amount of time in which the predetermined threshold needs to be met; and a predetermined threshold, wherein the predetermined threshold defines a number of secondary user-buyers prior to receiving the fulfillment request; receiving an association request from at least one secondary user-buyer for at least one selected intention of the list of intentions; receiving a fulfillment request from at least one user-seller for the at least one selected intention; the category includes: a competitive type intention, wherein the competitive type intention is configured to receive a plurality of fulfillment requests before the intention is fulfilled; and an opt-out type of intention configured to receive a plurality of disassociation requests from the primary or one of the at least one associated secondary user-buyers; receiving from the primary and the at least one associated secondary user-buyers a selection of a preferred user-seller of the plurality of fulfillment requests if the category is a competitive type intention; and providing a counter offer modality configured so that at least one user-seller modifies the deal terms, and requesting the primary and the at least one associated secondary user-buyers to approve the modified deal terms prior to receiving the fulfillment request, whereby the intention is fulfilled according to the deal terms.

In yet another aspect of the present invention, includes receiving each intention from a primary user-buyer associated with buying a good or service; receiving a search query including at least one category; and outputting search results of at least one intention responsive to the search query.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention, illustrating a buyer standard intention creation modality;

FIG. 2 is a flow chart of an exemplary embodiment of the present invention, illustrating a buyer search and execution of published standard intention modality;

FIG. 3 is a flow chart of an exemplary embodiment of the present invention, illustrating a seller intention creation modality;

FIG. 4 is a flow chart of an exemplary embodiment of the present invention, illustrating a seller search and execution of published standard intention modality;

FIG. 5 is a flow chart of an exemplary embodiment of the present invention, illustrating a buyer search and execution of published competitive intention modality;

FIG. 6 is a flow chart of an exemplary embodiment of the present invention, illustrating a seller search and execution of published competitive intention modality;

FIG. 7 is a flow chart of an exemplary embodiment of the present invention, illustrating a buyer opt-out intention creation modality;

FIG. 8 is a flow chart of an exemplary embodiment of the present invention, illustrating a buyer search and execution of published opt-out intention modality;

FIG. 9 is a flow chart of an exemplary embodiment of the present invention, illustrating a seller counter offer modality;

FIG. 10 is a flow chart of an exemplary embodiment of the present invention, illustrating a user-buyer registration modality; and

FIG. 11 is a flow chart of an exemplary embodiment of the present invention, illustrating a user-seller registration modality.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a community purchase model for providing transparency and information symmetry to marketplaces. The community purchase model provides a method for creating and publishing user-buyers' intentions to enter into a deal which other user-buyers can associate with, for setting the terms of the deal, for marketing the deal through their online social networks, and for user-sellers to commit to. Only if the intention is sufficiently fulfilled by a commitment of a user-seller does money change hands, thereby providing a transparent demand curve for predicting reasonable volume sales for the user-seller while generating a highly personalized deal for the user-buyer. And as a result, these collective intentions will create new equilibrium prices based on more symmetrical information.

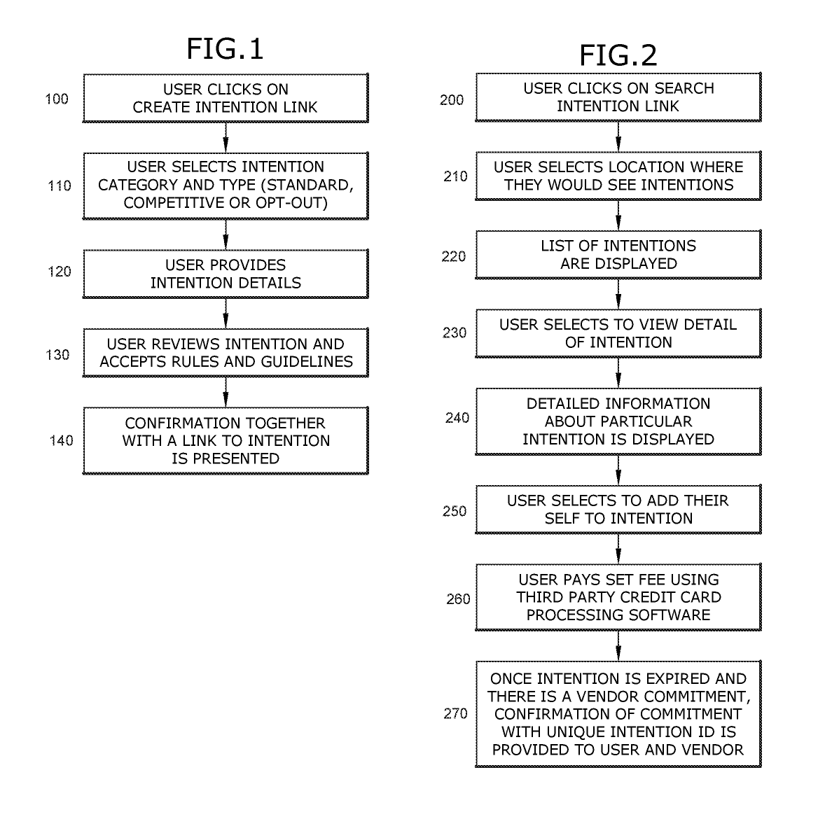

Referring to FIGS. 1 through 11, the present invention may include at least one computer with a user interface. The computer may include at least one processing unit coupled to a form of memory, wherein the computer includes, but is not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a community purchase model embodied in an online platform (website) coupled to a plurality of computers through at least one communication channel, wherein the online platform is coupled to at least one database.

The online platform may enable registered user-buyers and user-sellers to aggregate and commit to user-buyer intentions through transparent, informed methodologies. The online platform may enable user-buyers to create and publish at least three types of intentions to buy (“intentions”), wherein the user-buyer sets the terms of the deal.

The present invention may also enable user-buyers to selectively search for and commit/associate to/with pre-existing intentions. The system may provide user-sellers to review pre-existing intentions and modify the pre-set terms of the deal through a counter offer intention modality. The online platform may enable user-buyers to commit to/fulfill pre-existing intentions. The online platform may enable users to transact the intention-commitments through their social networks.

The at least three types of intentions include but are not limited to standard, competitive and opt-out intentions. Both user-buyers and user-sellers may selectively search through and review the different types of intentions. A plurality of user-sellers may commit/fulfill competitive intentions, though the associated user-buyers may select one preferred user-seller of the plurality of user-sellers. In opt-out intentions, associated user-buyers may opt out of the intention during a predetermined opt-out period.

The present invention may provide a community purchase model or system embodying methods for communal recording, association and execution (fulfillment) of user-defined intentions. The present invention collects commitments/fulfillments for the user-defined intentions, wherein the number of commitments is recorded in a specific intention record (database) and the purchase transaction is consummated if the number of user-seller commitments for the user-buyer intention reaches a predetermined threshold, wherein the predetermined threshold may be a quantity deemed economically advantageous to the user-seller. The system is adapted to enable the user-sellers to selectively browse (or be alerted/notified of) user-buyer intentions.

Furthermore, the system may be adapted to obtain a prepayment or a guarantee for payment for each intention through a payment mechanism with each commitment. In certain embodiments, the user-buyer creating an intention may set a cutoff time by when the number of commitments must reach the predetermined threshold (as determined by the user-seller) else the intention is cancelled. The user-sellers may selectively search through a filterable list of published intentions that they may be willing and able to fulfill. In addition, the user-sellers may be enabled to create counter offer intentions through the online platform.

Since the user-seller at all times may know how many user-buyers have committed—associated themselves—to a given intention, the demand curve is transparent and the user-seller can choose to fulfill the intention only when, and if, they find the terms and associated price of the intention to be financially attractive and advantageous to their particular business model.

Referring to FIG. 1, a method of using the community purchase model may include the following steps. In a buyer standard intention creation modality, a user-buyer may create an intention, possibly through creating a link through the online platform, in step 100. Then the user-buyer may select the intention category and type of intention, in step 110. Intentions may include, but not be limited to, a standard, a competitive, and an opt-out intention. Then the user-buyer may provide further intention details, in step 120. The intention details may include but not be limited to cutoff times, terms of the deal (like price, quantity, delivery, representations and warranties), and the like. Then the user-buyer may review the created buyer intention, and accept rules and guidelines associated with said created buyer intention, in step 130. Then the user may confirm and publish the buyer intention (link) through the online platform, in step 140.

Referring to FIG. 2, a method of using the community purchase model may include the following steps. In a buyer search and execution of published standard intention modality, a user-buyer may search for a published intention, possibly through filtering through a plurality of links represented through the online platform, in step 200. Then the user-buyer may filter by location, category, type of intention and intention details, in step 210. Then the online platform may represent the filtered published intentions, in step 220. Then the user-buyer may prompt the online platform to provide intention details associated with each selected published intention, in step 230. Then the online platform may represent the intention details associated with the selected published intention, in step 240. Then the user-buyer may associate their self to the selected published intention, in step 250. Then the user may pay a set fee via a payment mechanism through the online platform, in step 260. Then once the cutoff time of the selected published intention has expired and there is a user-seller commitment meeting the predetermined threshold, the online platform may generate a unique intention ID transmitted to all associated user-buyers, in step 270.

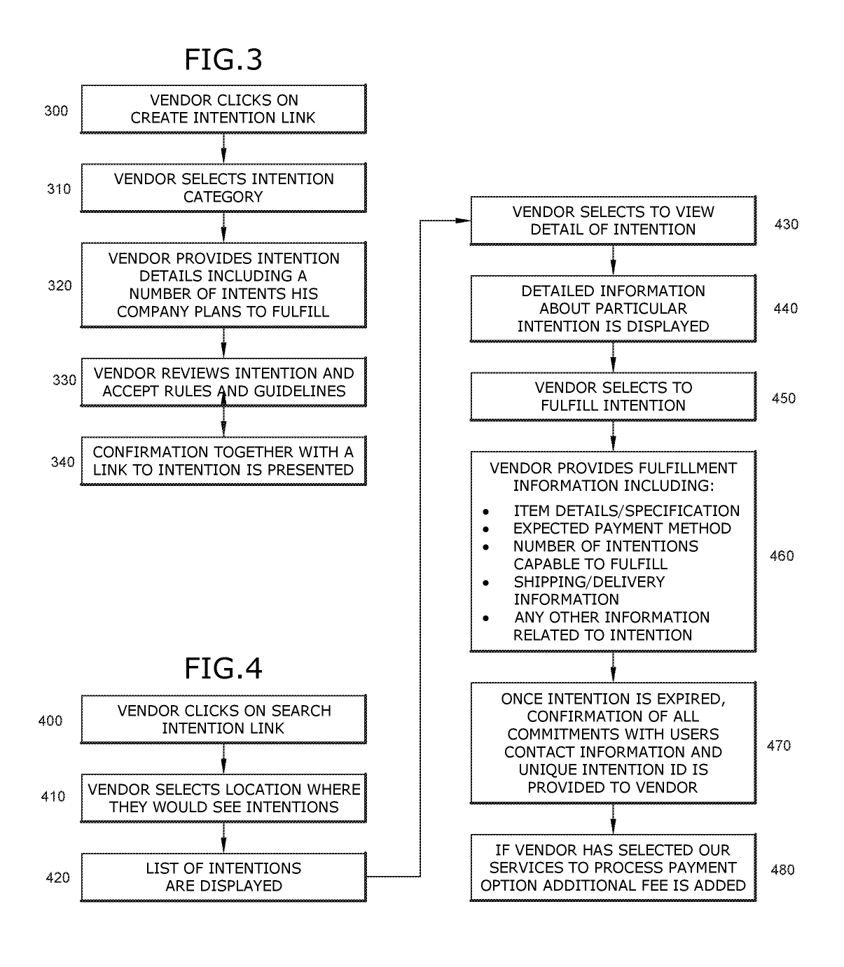

Referring to FIG. 3, a method of using the community purchase model may include the following steps. In a seller intention creation modality, a user-seller may create a seller intention, possibly through creating a link through the online platform, in step 300. Then the user-seller may select the intention category, in step 310. Then the user-seller may provide seller intention details, including but not limited to the number of intentions the seller intends to fulfill, in step 320. Then the user-seller may review the created seller intention and accept rules and guidelines associated with said created seller intention, in step 330.

Then the user-seller may confirm and publish the seller intention link through the online platform, in step 340.

Referring to FIG. 4, a method of using the community purchase model may include the following steps. In a seller search and execution of published standard intention modality, a user-seller may search for a published intention, possibly through filtering through a plurality of links represented through the online platform, in step 400. Then the user-seller may filter by location, category, and type of intention, and intention details, in step 410. Then the online platform may represent the filtered published intentions, in step 420. Then the user-seller may prompt the online platform to provide intention details associated with each selected published intention, in step 430. Then the online platform may represent the details associated with the selected published intention, in step 440. Then the user-seller may record their commitment to fulfill the selected published intention, in step 450. Then the user-seller may provide commitment fulfillment information through the online platform, including but not limited to item details/specifications; expected payment method provided by the payment mechanism; number of intentions capable of fulfilling; shipping/delivery information; and the like, in step 460. Once the selected published intention cutoff time has expired, then the online platform may confirm the recorded commitments with the unique intention ID, full vender information and fulfillment details provided to the associated user-buyers and the one preferred user-seller, in step 470. Then in step 480, the user-seller may engage the payment mechanism, wherein an additional fee may be added.

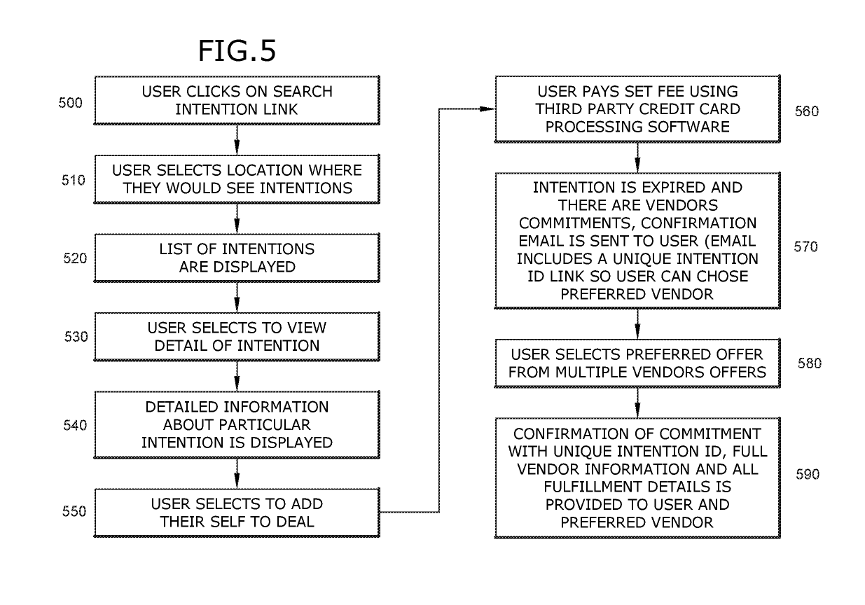

Referring to FIG. 5, a method of using the community purchase model may include the following steps. In a buyer search and execution of published competitive intention modality, a user-buyer may search for a published competitive intention, possibly through filtering through a plurality of links represented through the online platform, in step 200. Then the user-buyer may filter by location, category and type of intention as well as intention details, in step 510. Then the online platform may represent the filtered published intentions, in step 520. Then the user-buyer may prompt the online platform to provide intention details associated with each selected published competitive intention, in step 530. Then the online platform may represent the details associated with the selected published intention, in step 540. Then the user-buyer may associate their self to the selected published intention, in step 550. Then the user may pay a set fee via a payment mechanism through the online platform, in step 560. Then once the selected published intention's cutoff time has expired and there is a plurality of user-seller commitments meets or exceed the predetermined threshold, the online platform may generate a unique intention ID transmitted to all associated user-buyers for them to select one preferred user-seller of the plurality of user-seller commitments, in step 570. In step 580, the associated user-buyers select the one preferred user-seller. Then the confirmation of the commitment with the unique intention ID, full vender information and all fulfillment details may be provided to the associated user-buyers and the one preferred user-seller, in step 590.

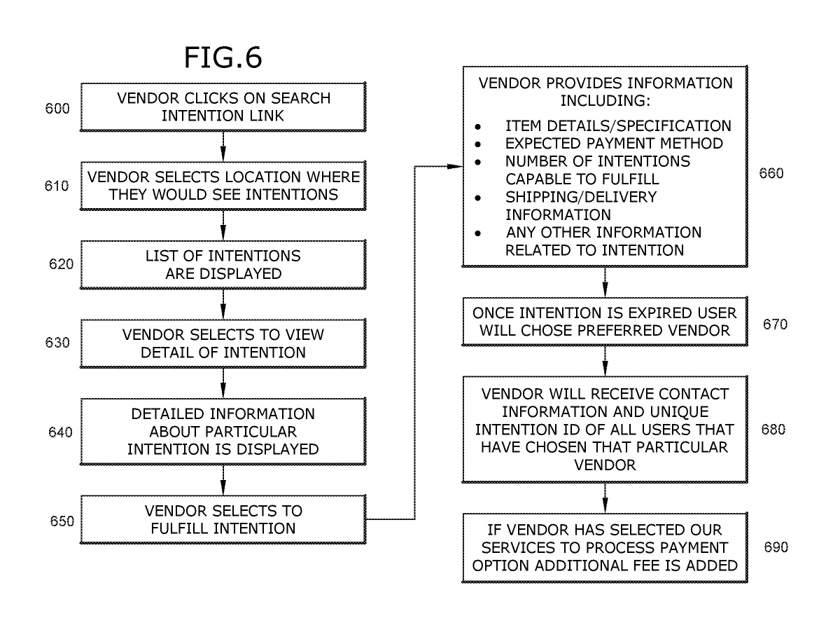

Referring to FIG. 6, a method of using the community purchase model may include the following steps. In a seller search and execution of published competitive intention modality, a user-seller may search for a published competitive intention, possibly through filtering through a plurality of links represented through the online platform, in step 600. Then the user-seller may filter by location, category, and type of intention and intention details, in step 610. Then the online platform may represent the filtered published competitive intentions, in step 620. Then the user-seller may prompt the online platform to provide intention details associated with each selected published competitive intention, in step 630. Then the online platform may represent the details associated with the selected published competitive intention, in step 640. Then the user-seller may record their commitment to fulfill the selected published competitive intention, in step 650. Then the user-seller may provide commitment fulfillment information through the online platform, including but not limited to item details/specifications; expected payment method provided by the payment mechanism; number of intentions capable of fulfilling; shipping/delivery information; and the like, in step 660. In step 670, then once the selected published competitive intention's cutoff time has expired, then associated user-buyers will select one preferred user-seller, as illustrated in FIG. 5. Then the online platform may transmit all associated unique intention IDs to the one preferred user-sellers, in step 680. Then in step 690, the user-seller may engage the payment mechanism, wherein an additional fee may be added.

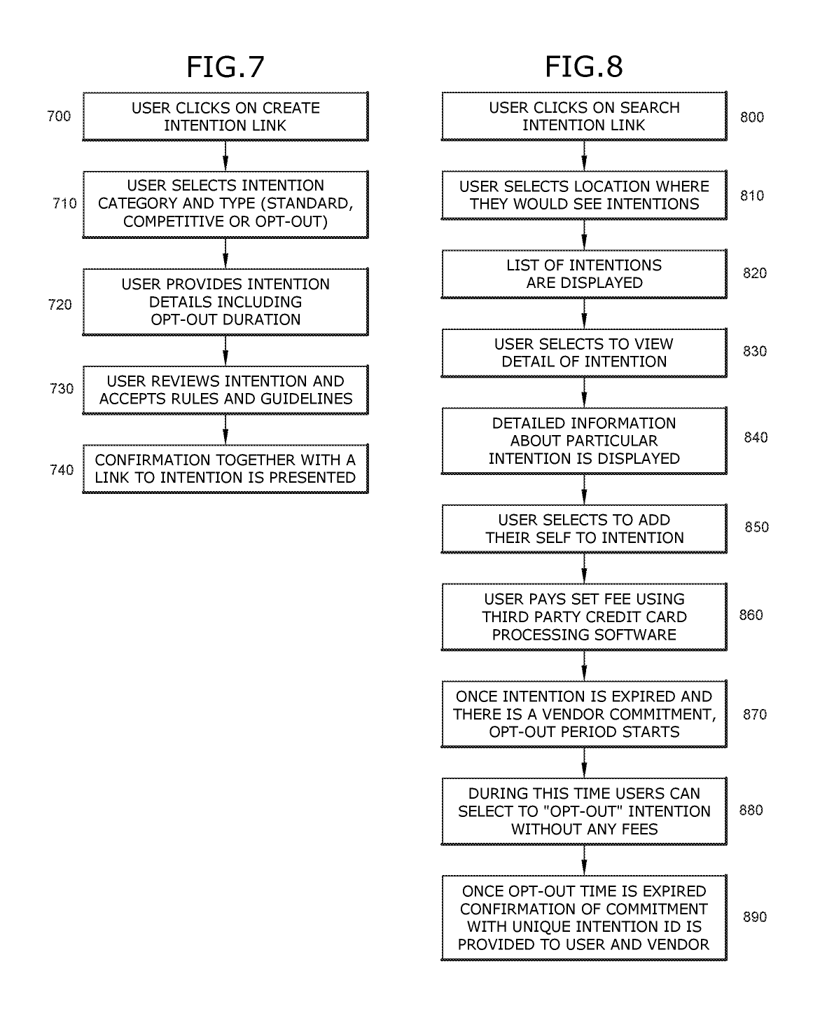

Referring to FIG. 7, a method of using the community purchase model may include the following steps. In a buyer opt-out intention creation modality, a user-buyer may create an opt-out intention, possibly through creating a link through the online platform, in step 700. Then the user-buyer may select the intention category and opt-out type of intention, in step 710. Then the user-buyer may provide further intention details including an opt-out duration, in step 720. Then the user-buyer may review the created buyer intention and accept rules and guidelines associated with said created buyer intention, in step 730. Then the user may confirm and publish the buyer intention link through the online platform, in step 740.

Referring to FIG. 8, a method of using the community purchase model may include the following steps. In a buyer search and execution of published opt-out intention modality, a user-buyer may search for a published opt-out intention, possibly through filtering through a plurality of links represented through the online platform, in step 800. Then the user-buyer may filter by location and intention details, in step 810. Then the online platform may represent the filtered published intentions, in step 820. Then the user-buyer may prompt the online platform to provide intention details associated with each selected published opt-out intention, in step 830. Then the online platform may represent the details associated with the selected published opt-out intention, in step 840. Then the user-buyer may associate their self to the selected published opt-out intention, in step 850. Then the user may pay a set fee via a payment mechanism through the online platform, in step 860. Then once the selected published intention's cutoff time has expired and there is a user-seller commitment meeting or exceeding the predetermined threshold, the opt-out duration starts, in step 870. During the opt-out duration, associated user-buyers may disassociate their self from the respective opt-out intention, in certain embodiments without a fee, in step 880. Once the opt-out duration has expired, then the online platform may confirm the recorded commitments with the unique intention ID, full vender information and fulfillment details provided to the associated user-buyers and the one preferred user-seller, in step 890.

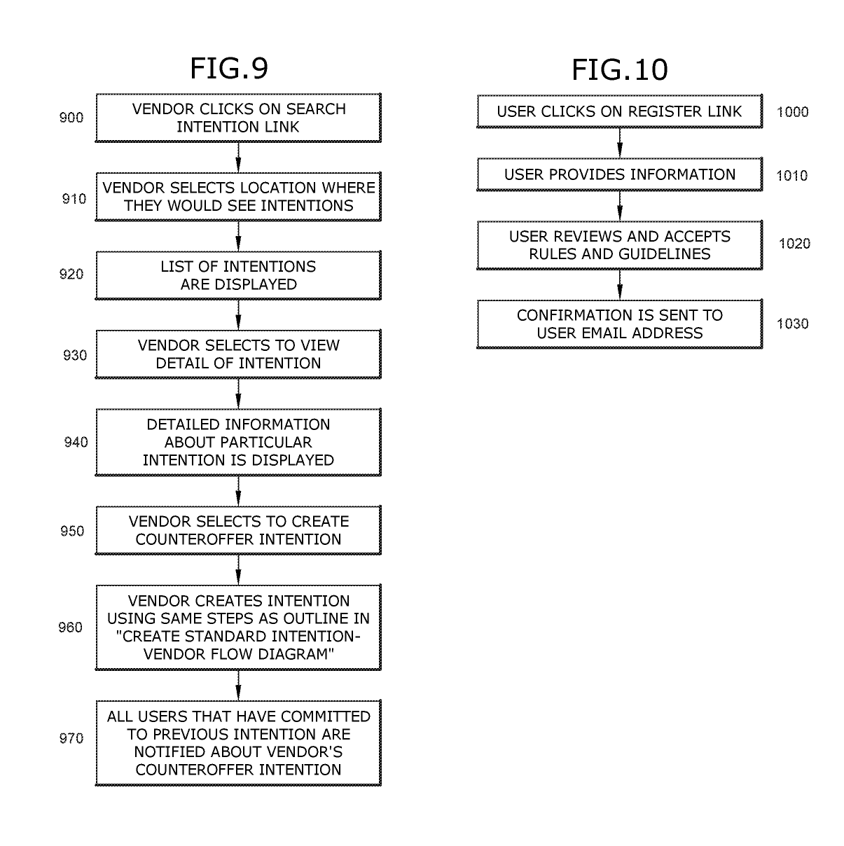

Referring to FIG. 9, a method of using the community purchase model may include the following steps. In a seller counter offer modality, a user-seller may search for a published competitive intention, possibly through filtering through a plurality of links represented through the online platform, in step 900. Then the user-seller may filter by location and intention details, in step 910. Then the online platform may represent the filtered published intentions, in step 920. Then the user-seller may prompt the online platform to provide intention details associated with each selected published intention, in step 930. Then the online platform may represent the details associated with the selected published intention, in step 940. Then the user-seller may select a pre-existing intention create an associated counter offer intention, in step 950, wherein, in step 960, the user-seller may follow the steps of FIG. 3. Then all the user-buyers associated with the selected pre-existing intention are notified of said created counter offer, in step 970.

Referring to FIG. 10, a method of using the community purchase model may include the following steps. In a user-buyer registration modality, a user-buyer may click on a registration link provided through the online portal, in step 1000. Then the user-buyer may provide identifying information, in step 1010. Then the user-buyer may review and accept the rules and guidelines imposed on user-buyers of the system, in step 1020. Then confirmation may be transmitted to the user-buyer, in step 1030.

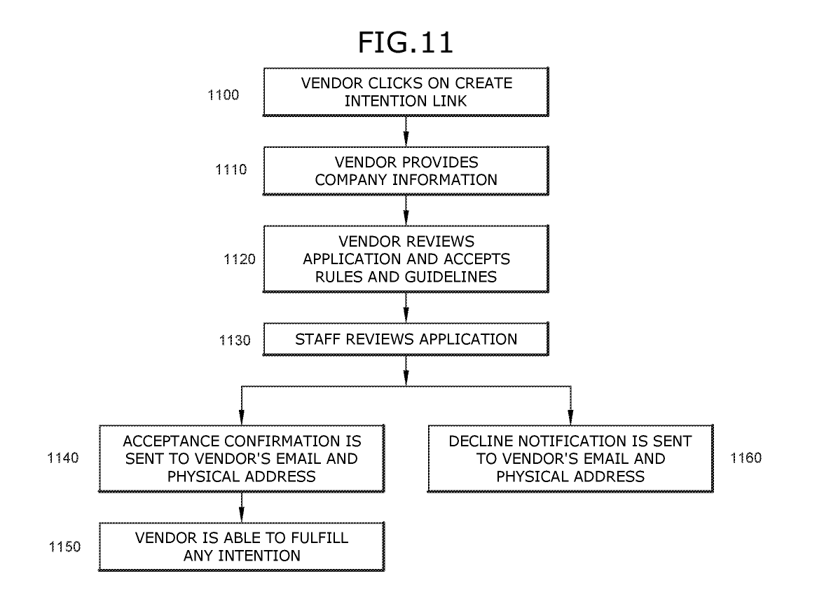

Referring to FIG. 11, a method of using the community purchase model may include the following steps. In a user-seller registration modality, a user-seller may click on a create an intention link provided through the online portal, in step 1100. Then the user-seller may provide identifying information, in step 1110. Then the user-seller may review and accept the rules and guidelines imposed on user-buyers of the system, whereby submitting a user-seller application, in step 1120. Then the system may be adapted to approve or disapprove said user-seller application, in step 1130. If the user-seller application is accepted, then acceptance may be transmitted to the user-seller, in step 1140. Thereby the user-seller may fulfill any intention through the system, in step 1150. If the user-seller application is declined, then declination may be transmitted to the user-seller, whereby the user-seller may not fulfill any intention through the system, in step 1160.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for providing a community purchase model, comprising the steps of:
publishing a list of intentions according to a category, wherein each intention is associated with a primary user-seller, wherein each intention includes a deal terms and a category of the intention, wherein the deal terms define a specifications of respective intention, and wherein the list is searchable according to the category or the deal terms;
receiving an association request from at least one secondary user-buyer for at least one selected intention of the list of intentions;
associating the at least one secondary user-buyer with the at least one selected intention; and
receiving a fulfillment request from at least one user-seller for the at least one selected intention,
whereby the intention is fulfilled according to the deal terms when only one fulfillment request is received.

2. The method of claim 1, wherein the deal terms include a predetermined threshold, wherein the predetermined threshold defines a number of secondary user-buyers prior to receiving the fulfillment request.

3. The method of claim 2, wherein the deal terms include a cutoff time, wherein the cutoff time defines an amount of time in which the predetermined threshold needs to be met.

4. The method of claim 1, wherein the category includes a competitive type intention, wherein the competitive type intention enables the receipt of a plurality of fulfillment requests before the intention is fulfilled.

5. The method of claim 4, further comprising the step of receiving from the primary and the at least one associated secondary user-buyers a selection of a preferred user-seller of the plurality of fulfillment requests, whereby the intention is fulfilled by the preferred user-seller.

6. The method of claim 3, wherein the category includes an opt-out type of intention; and further comprising the steps of:
receiving disassociation request from the primary or one of the at least one associated secondary user-buyers; and
disassociating from the primary or one of the at least one associated secondary user-buyers submitting the disassociation request prior to expiration of the cutoff time.

7. The method of claim 1, further comprising providing a counter offer modality configured so that at least one user-seller modifies the deal terms, and requesting the primary and the at least one associated secondary user-buyers to approve the modified deal terms prior to receiving the fulfillment request.

8. A computer implemented method for providing a community purchase model, comprising the steps of:
publishing a list of intentions according to a category, wherein each intention is associated with a primary user-seller, wherein each intention includes a deal terms and a category of the intention, and wherein the list is searchable according to the category or the deal terms;
the deal terms include:
a definition of a specifications of respective intention;
a cutoff time, wherein the cutoff time defines an amount of time in which the predetermined threshold needs to be met; and
a predetermined threshold, wherein the predetermined threshold defines a number of secondary user-buyers prior to receiving the fulfillment request;
receiving an association request from at least one secondary user-buyer for at least one selected intention of the list of intentions;
receiving a fulfillment request from at least one user-seller for the at least one selected intention;
the category includes:
a competitive type intention, wherein the competitive type intention is configured to receive a plurality of fulfillment requests before the intention is fulfilled; and
an opt-out type of intention configured to receive a plurality of disassociation requests from the primary or one of the at least one associated secondary user-buyers;
receiving from the primary and the at least one associated secondary user-buyers a selection of a preferred user-seller of the plurality of fulfillment requests if the category is a competitive type intention; and
providing a counter offer modality configured so that at least one user-seller modifies the deal terms, and requesting the primary and the at least one associated secondary user-buyers to approve the modified deal terms prior to receiving the fulfillment request, whereby the intention is fulfilled according to the deal terms.

9. The method of claim 8, further comprising the steps of:
receiving each intention from a primary user-buyer associated with buying a good or service;
receiving a search query including at least one category; and
outputting search results of at least one intention responsive to the search query.

10. The method of claim 1, further comprising the steps of:
receiving each intention from a primary user-buyer associated with buying a good or service;
receiving a search query including at least one category; and
outputting search results of at least one intention responsive to the search query.
